(19) United States
(12) Patent Application Publication
(10) Pub. No.: US 2006/0205840 A1
(43) Pub. Date: Sep. 14, 2006

(54) Ink-jet ink and ink jet recording method

(75) Inventors: Hisato Kato, Tokyo (JP); Kei Kudo, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC., Tokyo (JP)

(21) Appl. No.: 11/368,863

(22) Filed: Mar. 6, 2006

(30) Foreign Application Priority Data
Mar. 14, 2005 (JP) JP2005-070713

(51) Int. Cl. C03C 17/00

(52) U.S. Cl. 523/160

(57) ABSTRACT

An ink-jet ink is disclosed, comprising a water-soluble dye, a water-soluble organic solvent, water-dispersible polymer particles and a water-soluble resin, wherein the water-dispersible polymer particles have an average particle size 40 to 200 nm and a total content of the water-dispersible polymer particles and the water-soluble resin being 0.5% to 4.0% by weight of the ink and a ratio of a content of the water-soluble resin to that of the water-dispersible polymer particles being 0.1 to 1.0. An ink-jet recording method is also disclosed comprising ejecting the foregoing ink to allow the ink to deposit onto a porous type recording medium to form an image.

This application claims priority from Japanese Patent Application No. JF2005-070713, filed on Mar. 14, 2005, which is incorporated hereinto by reference.

### FIELD OF THE INVENTION

The present invention relates to a novel ink-jet ink, an ink-jet recording method and ink-jet recorded material.

### BACKGROUND OF THE INVENTION

Ink jet recording is a method in which microscopic ink droplets are flown based on various actuating principles and deposited on a recording sheet such as paper to record images or characters, having the advantages that multi-color recording can be achieved at a relatively low cost with a low noise level.

Recent advances in ink jet techniques are marked and their combination with advances of printer techniques, ink techniques and specific recording medium techniques, render it feasible to achieve recording of high image quality, approaching conventional photographic image quality. Along with enhancement of image quality, storage stability of ink jet images is compared to that of conventional silver salt photography. Specifically in dye inks, there has been pointed out deterioration accompanying movement of color materials, such as low water resistance or ink bleeding resistance of ink jet images, and deterioration accompanying chemical reactions due to characteristics of coloring materials, such as weakness in light fastness and low resistance to oxidizing gases. In addition thereto, recently, problems have arisen in discoloration of ink jet recorded images, due to a small amount of ozone contained in the atmosphere.

In order to overcome the foregoing problems, there has been attempted covering the image surface with resin film to enhance storage stability of dye ink-recorded images. JP-A Nos. 59-222381, 4-21446, 10-315448, 11-5362 and 11-192775, for example, disclose techniques in which a layer comprised of thermoplastic organic polymer particles is provided on the uppermost surface of a recording medium and after image-recording, the polymer particles are melted to form a film, resulting in formation of a polymeric protective film, thereby achieving improvement in water resistance and weather resistance and providing glossiness to images.

This method can contribute to enhances image storage stability to a certain extent but has problems in practice such that a special ink jet recording medium is needed, a heat-fixing device is needed, and blistering due to evaporation of ink solvent or peeling-off of which control is difficult, occurs at the time of heat-fixing. It was further shown that the uppermost layer containing thermoplastic organic polymer particles disadvantageously inhibit ink absorptivity.

There was disclosed a method in which incorporation of a polymer latex of a particulate polymer into an ink-jet ink enhanced water resistance and light fastness, as described in JP-A Nos 55-18412 and 11-199808. There was also disclosed incorporation of a polymer latex into an ink-jet ink to enhance resistance to ozone gas, as described in JP-A No. 2002-24041. Further, JP-A Nos. 2002-80759, 2002-194253, 2002-264490, 2002-285049 and 2003-55586 disclosed techniques of incorporation of a polymer latex or a particulate polymer.

It was proved that in the ink-jet ink described in the foregoing disclosures, incorporation of a polymer latex or a particulate polymer into an ink-jet ink contributed to enhancement of ozone gas resistance to some extent but its effect was insufficient specifically in portions of low ink coverage. The foregoing techniques often resulted in lowered ink absorptivity, causing beading or color bleed and leading to deteriorated image quality. Such problems were marked specifically in the recent trend of increased printing speed and an ink jet printer giving a high ink coverage of light and deep color inks.

Film formation of the polymer latex contained in the ink-jet ink on the image surface was expected to result in enhanced glossiness. However, it was proved that the embodiments described in the foregoing disclosures could not achieve high glossiness but resulted in lowered glossiness.

### SUMMARY OF THE INVENTION

In light of the foregoing problems, it is an object of the present invention to provide an ink-jet ink resulting in ink-jet prints exhibiting enhanced resistance to ozone fade, superior ink absorptivity and ink ejectability, enhanced glossiness and enhanced surface strength, and an ink-jet recording method by use thereof.

In one aspect the invention is directed to an ink-jet ink containing a water-soluble dye, a water-soluble organic solvent and water-dispersible polymer particles, wherein the average particle size of the water-dispersible polymer particles is from 40 to 200 nm and the ink further contains a water-soluble resin. The total content of the water-dispersible polymer particles and the water-soluble resin is preferably 0.5% to 4.0% by weight of the ink and a ratio of the content of the water-soluble resin to that of the water-dispersible polymer particles being 0.1 to 1.0.

In another aspect the invention is directed to an ink-jet recording method comprising ejecting an ink as described above to allow the ink to deposit onto a porous type recording medium to form an image.

In another aspect the invention is directed to an ink-jet record recorded by the foregoing ink-jet recording method.

### DETAILED DESCRIPTION OF THE INVENTION

There has been known incorporation of water-soluble resins into an ink-jet ink (hereinafter, also denoted simply as an ink) and for instance, JP-A Nos. 2003-231844 and 2003-231845 describe the use as a viscosity-adjusting agent.

Effects of containing this water-soluble resin in the ink of this invention are distinct from those of the prior art.

Enhancements of resistance to ozone gas and glossiness are supposed to be achieved by addition of a water-soluble resin, as follows. Thus, a water-soluble resin relating to this invention penetrates into regions in which film formation by water-dispersible polymer particles is incomplete on a ink-jet recording medium (hereinafter, also denoted simply as recording medium) and fill the interior of the region, enabling to achieve complete film formation and resulting in marked enhancements of ozone gas resistance and glossiness, and improved surface strength of a recording medium.

When the addition amount of water-dispersible polymer particles is increased or its average particle size is decreased, the water-dispersible polymer particles as a water-insoluble component fill or minimize voids in the interior of the ink-jet recording medium, resulting in reduced ink-absorptivity. Further incorporating a water-soluble resin thereto inhibits lowering of ink absorptivity.

Higher ejection stability can be achieved by the combined use of water-dispersible polymer particles and a water-soluble resin. Thus, it was proved that clogging of nozzles due to drying, could be prevented by adjustment of an addition amount of water-dispersible polymer particles and the combined use of water-dispersible polymer particles and a water-soluble resin prevented nozzle clogging caused by dried materials (film-formed material) of the water-dispersible polymer particles when ink dries at the nozzle orifice. Further, ink-jet recording by using a recording medium of a relatively low surface strength often produced problems such as image loss on a recorded image, caused by transport rollers (which is also called notched digging). It was also proved that the combined use of water-dispersible polymer particles and a water-soluble resin improved such notched digging.

Although incorporating water-dispersible polymer particles or a water-soluble resin to an ink is described in the foregoing disclosure of the prior art, nothing is described therein with respect to enhancement of ink absorptivity or glossiness, while noting that a water-soluble resin is added to a water-soluble dye ink containing water-dispersible polymer particles.

There will be further detailed water-dispersible polymer particles relating to this invention.

In one aspect, the ink of this invention contains a water-soluble resin together with a water-soluble dye, a water-soluble organic solvent and water-dispersible polymer particles. One preferred embodiment of the ink of this invention is a water-based ink comprising water as the main solvent.

First, water-dispersible polymer particles will be described. The water-dispersible polymer particles relating to this invention refers to polymer particles in a state of being dispersed in a medium, e.g., water and also denoted as polymer particles (or particulate polymer) or a latex.

The water-dispersible polymer particles are usable in the form of an aqueous dispersion of various polymers. Specific examples of such polymers include acryl polymer, acrylonitrile-acryl copolymer, vinyl acetate polymer, vinyl acetate-acryl copolymer, vinyl acetate-vinyl chloride copolymer, urethane polymer, silicone-acryl copolymer, acrylsilicone polymer, polyester, epoxy polymer.

Usually, these water-dispersible polymer particles can be obtained through emulsion polymerization. Surfactants and polymerization initiators used therein are those which are conventionally used. Synthesis methods of water-dispersible polymer particles are described in U.S. Pat. Nos. 2,852,368, 2,853,457, 3,411,911, 3,411,912 and 4,197,127; Belgian Patent Nos. 688,882, 691,360 and 712,823; JP-B No. 45-5331 (hereinafter, the term, JP-B refers to Japanese Patent Publication); JP-A Nos. 60-18540, 51-13021758-137831 and 55-50240.

The average particle size of water-dispersible polymer particles needs to be chosen, taking into account prevention of ozone-fading, coloring property, print glossiness, ink absorptivity and the like. To obtain prints exhibiting superior coloring property and print glossiness, the average particle size is preferably from 40 nm to 200 nm, and more preferably 40 to 150 nm, and still more preferably 40 to 100 nm. An average particle size of water-dispersible polymer particles, falling within the range of 40 to 200 nm results in enhanced coverage of the polymer particles on the recording medium, rendering it feasible to be compatible with ejection stability of ink droplets. Thus, an average particle size of 40 nm or more achieves sufficient coverage of the printed image surface with polymer particles, leading to improved image storage stability. An average particle size of not more than 200 nm results in enhanced ejection stability of ink droplets.

Selection of water-dispersible polymer particles having an average particle size falling within the above-described range results in marked desired effects thereof, specifically when printed on a porous (or pore type) ink-jet recording medium. When plural kinds of water-dispersible polymer particles differing in average particle size are used, it is preferred to adjust the average particle size of all the particles to fall within the above range.

The average particle size of water-dispersible polymer particles can be determined using a commercially available particle size measuring instrument, for example, ZETACIZER 1000 (produced by Marbahn Co.).

There can be chosen water-dispersible polymer particles which form a barrier layer exhibiting fade resistance to ozone gas after being deposited on the recording medium. It is therefore preferred to choose water-dispersible polymer particles exhibiting superior capability of forming a film on the ink-jet recording medium. It is effective to choose water-dispersible polymer particles with noting their physical properties, such as a glass transition temperature (Tg) or a minimum film-forming temperature (MFT). It is specifically effective to choose water-dispersible polymer particles capable of forming a film at room temperature, eliminating a step to promote film formation after printed.

The glass transition temperature (Tg) of water-dispersible polymer particles is preferably from −30 to 80° C., and more preferably −20 to 50° C. A glass transition temperature (Tg) of water-dispersible polymer particles of not less than −30° C. resists clogging near the nozzle orifice of a recording head and a transition temperature of not more than 80° C. can achieve preferable film forming ability.

The glass transition temperature (Tg) of polymer particles can be determined by commonly known methods, employing the characteristic that a thermal expansion coefficient or specific heat discontinuously varies in the course of varying temperature, as also detailed in J. Brandup, E.H. Immergu, Polymer Handbook, 3rd Ed. (John Wily & Sons) 1989, VI, page 209-277.

The minimum film-forming temperature (also denoted as MFT) of the water-dispersible polymer particles relating to this invention is preferably from 0 to 80° C., more preferably 0 to 50° C., and still more preferably 0 to 30° C. The minimum film-forming temperature (MFT) refers to the lowest temperature at which the water-dispersible polymer particles can form film. There may be added a film-forming aid to control the minimum film-forming temperature of water-dispersible polymer particles. The film-forming aid is also called a plasticizer, which is an organic compound (usually, an organic solvent) lowering the minimum film-forming temperature of a polymer latex. Examples thereof are described in, for instance, S. Muroi “Gosei Latex no Kagaku” (Chemistry of Synthetic Latex, Kobunshi Kankokai, 1970).

The charge of water-dispersible polymer particles relating to this invention can be chosen with the following point of view.

Cationic polymer particles are not preferred to control storage stability or physical property of an ink so as to fall within a preferable range. Nonionic polymer particles are preferred to achieve enhanced color formation and superior glossiness. Preferred polymer particles are those which are dispersed by using a nonionic surfactant or a protective colloid such as PVA. Further thereto, a small amount of an anionic surfactant, or a polymer partially composed of a monomer containing an acid group may be used to enhance dispersibility.

Water-dispersible polymer particles may be added to a specific ink but addition to all inks is more preferred. Similar addition is preferred even in the case of a set of inks having the same color and differing in colorant concentration. In that case, the addition amount may be varied depending on the kind of an ink and the colorant concentration. Selection thereof can be made taking into account fade resistance to ozone, a color forming property, effectuation of glossiness and an ink-ejection property. When using a set of inks having the same color and differing in colorant concentration, addition of water-dispersible polymer particles to an ink at a lower concentration in a more amount results in enhanced fade resistance to ozone and reduced difference in glossiness within the image, leading to enhanced uniformity of glossiness.

When containing at least two kinds of water-dispersible polymer particles, at least one of them having an average particle size of 40 to 200 nm, and the other one having an average particle size of 300 nm or more and exhibiting a Tg or a MFT of 50° C. or more, the is result in effectiveness in abrasion resistance and prevention of blocking during storage in an album. When containing at least two kinds of water-dispersible polymer particles, the use of ones differing in charge specie or charge amount is preferable in terms of effectuation of glossiness and enhancement of abrasion resistance.

It is preferred to choose water-dispersible polymer particles which are capable of being dispersible even after being dried near the nozzle exit of the head. It is also preferred to use water-dispersible polymer particles exhibiting UV absorptivity or anti-fading ability for an antioxidant.

Next, there will be described water-soluble resin relating to this invention.

The water-soluble resin relating to this invention is a polymeric compound substantially dissolved in the ink. Specific examples thereof include water-soluble polymers such as polyvinyl alcohol, silanol-modified polyvinyl alcohol, carboxymethyl cellulose, hydroxyethyl cellulose, polyvinyl pyrrolidone, polyalkyleneoxide, e.g., polyethylene oxide or polypropylene oxide, and polyalkylene oxide derivatives; natural water-soluble polymers such as polysaccharides, starch, cationic starch, casein and gelatin, aqueous acryl resin such as polyacrylic acid, polyacrylamide and copolymer thereof; and aqueous alkyd resin. Of these, polyvinyl alcohol, carboxymethyl cellulose and polyethylene oxide are preferred. Combined use of at least two of these is also feasible.

The molecular weight or Tg of a water-soluble resin is effective similarly to the case of the combined use of at least two kinds of water-dispersible polymer particles.

Addition of a water-soluble resin to the ink further enhances fade resistance to ozone, glossiness and ink ejection property, achieved by polymer particles, reducing deterioration of image quality due to lowering in ink absorption speed.

A water-soluble resin can be added within the range of 0.2% to 2.0% by weight, preferably 0.2% to 1%.

The ink relating to this invention preferably has a total content of water-dispersible polymer particles and a water-soluble resin of 0.5% to 4.0% by weight of the ink. A total content of 0.5% by weight or more results in a sufficient effect on fading and a total content of 4.0% by weight or less stabilizes ink ejection and reducing an increase in ink viscosity during storage.

In the ink relating to this invention, the solid content ratio of a water-soluble resin to water-dispersible polymer particles is preferably in the range of 0.2 to 1.0. Specifically, selection with taking into account the ink absorption rate is important to obtain high quality images and its effects are marked when making print on a porous recording medium.

Subsequently, water-soluble dyes usable in the ink of this invention will be described below.

Examples of water-soluble dyes include azo dyes, azomethine dyes, xanthene dyes, and quinone dyes. Specific examples of a water-soluble dye are shown below but are not limited to these exemplified compounds.

C.I. Acid Yellow:

1, 3, 11, 17, 18, 19, 23, 25, 36, 38, 40, 42, 44, 49, 59, 61, 65, 67, 72, 73, 79, 99, 104, 110, 114, 116, 118, 121, 127, 129, 135, 137, 141, 143, 151, 155, 158, 159, 169, 176, 184, 193, 200, 204, 207, 215, 219, 220, 230, 232, 235, 241, 242, 246

C.I. Acid Orange:

3, 7, 8, 10, 19, 24, 51, 56, 67, 74, 80, 86, 87, 88, 89, 94, 95, 107, 108, 116, 122, 127, 140, 142, 144, 149, 152, 156, 162, 166, 168

C.I. Acid Red:

1, 6, 8, 9, 13, 18, 27, 35, 37, 52, 54, 57, 73, 82, 88, 97, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, 415

C.I. Acid Violet:

17, 19, 21, 42, 43, 47, 48, 49, 54, 66, 78, 90, 97, 102, 109, 126

C.I. Acid Blue:

1, 7, 9, 15, 23, 25, 40, 62, 72, 74, 80, 83, 90, 92, 103, 104, 112, 113, 114, 120, 127, 128, 129, 138, 140, 142, 156, 158, 171, 182, 185, 193, 199, 201, 203, 204, 205, 207, 209, 220, 221, 224, 225, 229, 230, 239, 249, 258, 260, 264, 278, 279, 280, 284, 290, 296, 298, 300, 317, 324, 333, 335, 338, 342, 350

C.I. Acid Green:

9, 12, 16, 19, 20, 25, 27, 28, 40, 43, 56, 73, 81, 84, 104, 108, 109

C.I. Acid Brown:

2, 4, 13, 14, 19, 28, 44, 123, 224, 226, 227, 248, 282, 283, 289, 294, 297, 298, 301, 355, 357, 413

C.I. Acid Black:

1, 2, 3, 24, 26, 31, 50, 52, 58, 60, 63, 107, 109, 112, 119, 132, 140, 155, 172, 187, 188, 194, 207, 222

C.I. Direct Yellow:

8, 9, 10, 11, 12, 22, 27, 28, 39, 44, 50, 58, 86, 87, 98, 105, 106, 130, 132, 137, 142, 147, 153

C.I. Direct Orange:

6, 26, 27, 34, 39, 40, 46, 102, 105, 107, 118

C.I. Direct Red:

2, 4, 9, 23, 24, 31, 54, 62, 69, 79, 80, 81, 83, 84, 89, 95, 212, 224, 225, 226, 227, 239, 242, 243, 254

C.I. Direct Violet: 9, 35, 51, 66, 94, 95

C.I. Direct Violet:

1, 15, 71, 76, 77, 78, 80, 86, 87, 90, 98, 106, 108, 160, 168, 189, 192, 193, 199, 200, 201, 202, 203, 218, 225, 229, 237, 244, 248, 251, 270, 273, 274, 290, 291

C.I. Green:

26, 28, 59, 80, 85

C.I. Direct Brown:

44, 106, 115, 195, 209, 210, 222, 223

C.I. Direct Black:

17, 19, 22, 32, 51, 62, 108, 112, 113, 117, 118, 132, 146, 154, 159, 169

C.I. Basic Yellow:

1, 2, 11, 13, 15, 19, 21, 28, 29, 32, 36, 40, 41, 45, 51, 63, 67, 70, 73, 91

C.I. Basic Orange:

2, 21, 22

C.I. Basic Red:

1, 2, 12, 13, 14, 15, 18, 23, 24, 27, 29, 35, 36, 39, 46, 51, 52, 69, 70, 73, 82, 109

C.I. Basic Violet:

1, 3, 7, 10, 11, 15, 16, 21, 27, 39

C.I. Basic Blue:

1, 3, 7, 9, 21, 22, 26, 41, 45, 47, 52, 54, 65, 69, 75, 77, 92, 100, 105, 117, 124, 129, 147, 151

C.I. Basic Green:

1, 4

C.I. Basic Brown:

1

C.I. Reactive Yellow:

2, 3, 7, 15, 17, 18, 22, 23, 24, 25, 27, 37, 39, 42, 57, 69, 76, 81, 84, 85, 86, 87, 92, 95, 102, 105, 111, 125, 135, 136, 137, 142, 143, 145, 151, 160, 161, 165, 167, 168, 175, 176

C.I. Reactive Orange:

1, 4, 5, 7, 11, 12, 13, 15, 16, 20, 30, 35, 56, 64, 67, 69, 70, 72, 74, 82, 84, 86, 87, 91, 92, 93, 95, 107

C.I. Reactive Red:

2, 3, 5, 8, 11, 21, 22, 23, 24, 28, 29, 31, 33, 35, 43, 45, 49, 55, 56, 58, 65, 66, 78, 83, 84, 106, 111, 112, 113, 114, 116, 120, 123, 124, 128, 130, 136, 141, 147, 158, 159, 171, 174, 180, 183, 184, 187, 190, 193, 194, 195, 198, 218, 220, 222, 223, 228, 235

C.I. Reactive Violet:

1, 2, 4, 5, 6, 22, 23, 33, 36, 38

C.I. Reactive Blue:

2, 3, 4, 5, 7, 13, 14, 15, 19, 21, 25, 27, 28, 29, 38, 39, 41, 49, 50, 52, 63, 69, 71, 72, 77, 79, 89, 104, 109, 112, 113, 114, 116, 119, 120, 122, 137, 140, 143, 147, 160, 161, 162, 163, 168, 171, 176, 182, 184, 191, 194, 195, 198, 203, 204, 207, 209, 211, 214, 220, 221, 222, 231, 235, 236

C.I. Reactive Green:

8, 12, 15, 19, 21

C.I. Reactive Brown: 2, 7, 9, 10, 11, 17, 18, 19, 21, 23, 31, 37, 43, 46

C.I. Reactive Black:

5, 8, 13, 14, 31, 34, 39.

The foregoing dyes are described in “Senshoku Note” 2nd. Ed. (published by Shikisen-sha).

The water-soluble dye content can be chosen within the range of 0.1% to 20% by weight of a water-soluble dye ink. It is preferred to employ so-called light and deep color inks prepared by varying the content of water-soluble dyes to form photographic images in ink-jet printing. The use of special color inks of red, green, blue and the like is preferred for color reproduction.

Next, water-soluble organic solvents usable in the ink of the invention will be described below.

Examples of a water-soluble organic solvent usable in this invention include alcohols (e.g., methanol, ethanol, propanol, pentanol, hexanol, cyclohexanol, benzyl alcohol), polyhydric alcohols (e.g., ethylene glycol, diethylene glycol, triethylene glycol, polyethylene glycol, propylene glycol, dipropylene glycol, tripropylene glycol, polypropylene glycol, butylenes glycol, hexanediol, pentanediol, glycerin, hexanetriol, thiodiglycol), polyhydric alcohol ethers (e.g., ethylene glycol monomethyl ether, ethylene glycol monoethyl ether, ethylene glycol monobutyl ether, ethylene glycol monophenyl ether, diethylene glycol monomethyl ether, diethylene glycol monoethyl ether, diethylene glycol monobutyl ether, propylene glycol monomethyl ether, propylene glycol monoethyl ether, propylene glycol monobutyl ether, ethylene glycol monomethyl ether acetate, triethylene glycol monomethyl ether, triethylene glycol monoethyl ether, triethylene glycol monobutyl ether, triethylene glycol dimethyl ether, dipropylene glycol monopropyl ether, tripropylene glycol dimethyl ether), amines (e.g., ethanolamine, N-diethanolamine, morpholine, N-ethylmorpholine, ethylenediamine, diethylenediamine, triethylenetetramine, tetraethylenepentamine, polyethyleneimine, pentamethyldiethylenetriamine, tetramethylpropylenediamine), amides (e.g., formamide, N,N-dimethylfromamide, N,N-dimethylacetoamide), heterocyclic compounds (e.g., 2-pyrrolidone, N-methyl-2-pyrrolidone, N-cyclohexyl-2-pyrrolidone, 2-oxazolidone, 1,3-dimethyl-2-imidazolidine), sulfoxides (e.g., dimethylsulfoxide) and sulfones (e.g., sulfolane).

In this invention, surfactants may be added to control surface tension. There are usable anionic, cationic, amphoteric and nonionic surfactants. Typical examples thereof include anionic surfactants such as a carboxylate, an alkylsulfate, an alkyl sulfuric acid ester, an alkylbenzenesulfonate, an alkylnaphthalenesulfonates, a dialkylsulfosuccinates, an alkylphosphoric acid ester salt, an alkylnaphthalenesulfonic acid formalin condensate; cationic surfactants such as an amine salt, a tetraalkyl quaternary ammonium salt, a trialkyl quaternary ammonium salt, an alkylpyridium salt, and an alkylquinolinium salt; nonionic surfactants such as a polyoxyethylene alkyl ether, a polyoxyethylene alkylphenyl ether, a polyoxyethylene carboxylic acid ester, polyoxyethylene sorbitan carboxylic acid ester, polyoxyethylene alkylamine, ethylene oxide adduct of polypropylene glycol, acetylene glycol and ethylene oxide adduct of acetylene glycol.

For the purpose of enhancements of ejection stability, compatibility with the print head or an ink cartridge, storage stability or other characteristics, the ink of this invention may be added with a viscosity adjusting agent, a specific resistance adjusting agent, a film forming agent, an ultraviolet absorbing agent, an antioxidant, an antiseptic agent, an anti-fungal agent, an antirust, a pH-adjusting agent, a dye dissolving aid, a defoamer or a metal chelating agent.

Preferred examples of an antiseptic or anti-fungal agent include sodium benzoate, sodium pentachlorophenol, sodium 1-pyridinethio-1-oxide, sodium sorbitate, sodium dehydroacetate, 1,2-benzisothiazolidine-3-one (e.g., Proxel CRL, Proxel BD, Proxel GXL, Proxel TN, Proxel XL-2, produced by Avecia Ltd.) and 4-chloro-3-methylphenol (e.g., Preventol CMK, produced by Bayer).

Examples of a pH-adjusting agent include amines and their modifiers such as diethanolamine, triethanolamine, propanolamine and morpholine; inorganic salts such as potassium hydroxide, sodium hydroxide and lithium hydroxide; ammonim hydroxide; quaternary ammonium hydroxide (e.g., tetramethylammonium); carbonates such as potassium carbonate, sodium carbonate and lithium carbonate; and phosphates.

Examples of a dye-dissolving aid include ureas such as urea, thiourea and tetramethylurea.

The viscosity of an ink-jet ink of this invention is preferably chosen to be within the range of 1.5 to 10 mPa·s, more preferably 3.0 to 8 mPa·s. The surface tension of an ink-jet ink of this invention is chosen to be preferably within the range of 20 to 50 mN/m, more preferably 25 to 45 mN/m.

It is preferred in the ink-jet recording method of this invention to employ a substantially colorless ink containing a water-dispersible polymer particles and a water-soluble resin, together with inks of this invention.

The colorless ink basically contains no colorant, but there may be added a colorant as an impurity or a small amount of a dye, a pigment or a fluorescent brightener to allow the white background of an ink-jet recording medium to approach that of a printing sheet.

The colorless ink can contain a water-dispersible polymer particles and a water-soluble resin to form a protective film.

The polymer particles can use those described in JP-A Nos. 2002-264465, 2002-201428 and published international application WO 00/06390. Such polymer particles preferably are those of an emulsion polymerization dispersion obtained by emulsion polymerization of a vinyl monomer. Examples of such a vinyl monomer include ethylene, propylene, isoprene, butadiene, pentadiene, vinyl chloride, vinylidene chloride, styrene, divinylbenzene, vinyltoluene, acrylic acid and its salt, methacrylic acid and its salt, acrylamide, itaconic acid and its salt, maleic acid and its salt, methyl vinyl ether, acrylic acid or methacrylic acid derivatives (e.g. methyl ester, ethyl ester, benzyl ester, butyl ester), N-substituted acrylamide or N-substituted methacrylamide derivatives, vinyl acetate, N-vinylpyrrolidone, and 2-vinyloxazolidone, bur are not limited to the foregoing. These monomers may be singly polymerized or may be copolymerized in combination.

A preferred polymer dispersion can be obtained by allowing one or more of the foregoing monomers to polymerize in the presence of a polymerization initiator. Emulsion polymerization is conducted preferably in the presence of a surfactant or a hydrophilic polymer to control the particle size of the emulsion or to enhance stability.

Emulsion polymerization using a surfactant can obtain relatively fine particles but when used in a colorless ink, it needs to choose a surfactant having no adverse effects on surface tension or the like required in the ink.

A colorless ink may optionally contain a compound having ultraviolet absorbing capability or a compound having an anti-oxidizing function. There may be used a polymer dispersion obtained by emulsion polymerization of monomers having such functions.

Similarly to the ink of this invention, a colorless ink may contain various additives such as a water-soluble organic solvent, a surfactant, a viscosity adjusting agent or an antiseptic agent.

A colorless ink may be mixed with the water-soluble dye ink of this invention. Accordingly, it is desired that when mixed, no coagulation of colorants substantially occurs and specifically, the variation of absorbance of the water-soluble dye ink is less than 5%. A specific method thereof is performing mixing on the ink-jet recording medium. When a colorless ink and a water-soluble dye ink are each supplied through ink jet nozzles, there often occurs staining by both inks. There is also a case where the same head is employed for either a recording ink or a colorless ink according to the printing mode. In light of the foregoing circumstances, when a water-soluble dye ink of this invention and a colorless ink are mixed, the variation of absorbance is preferably less than 5% of the absorbance-immediately after being mixed, whereby deterioration of image quality or lowering of glossiness is minimized.

In this invention, a colorless ink is ejected preferably by an ink droplet-providing means which is installed separately from a means for ejecting the water-soluble dye ink of this invention. For instance, recording heads are prepared for five colors and specially used for each of yellow, magenta, cyan, black and colorless inks, and ejection of the colorless ink is preferably performed concurrently with image formation by recording heads. In that case, water-soluble dye inks of this invention and a colorless ink need to be mixed with each other on the recording medium before being absorbed by the recording medium, resulting in a lowered degree of freedom of constitution of recording inks and a colorless ink. In order to avoid this, sites for ejecting water-soluble dye inks and a site for ejecting the colorless ink are each separately provided. Alternatively, after completing ejection of either ink, the other ink may be ejected.

In the ink-jet recording method of this invention, it is preferred in order to allow this invention to come into effect that a colorless ink is uniformly deposited onto a non-printed area of a porousness-type ink-jet recording medium at a ink deposition amount per unit area of the recording medium which is more than that of a water-soluble dye ink.

Next, there will be detailed a porous type ink-jet recording medium used in the ink-jet recording method of this invention.

The ink-jet recording medium relating to this invention comprises an ink absorbing layer on a support. In general, the ink absorbing layer is classified mainly into a swelling type and a porous type. A porous type ink-jet recording medium which is provided with a layer having a porous structure (hereinafter, also denoted as a porous layer) is preferable in this invention.

In the porous type ink-jet recording medium, a porous layer containing fine-particles, a water-soluble binder and a cationic polymer, preferably exhibits a ratio of (fine-particles)/(water-soluble binder+cationic polymer), also designated as F/R, of 3 to 12.

There have been known various methods of forming pores in the interior of film. Examples thereof include a method in which a coating solution containing at least two kinds of polymers is coated on a support and the polymers are allowed to phase-separate from each other in the drying stage to form pores; a method in which a coating solution containing solid particles and a hydrophilic or hydrophobic resin is coated on a support, dried and then immersed in water or a solution containing an appropriate organic solvent to allow the solid particles to be solubilized to form pores; a method in which a coating solution containing a compound capable of foaming (or a foaming agent) to form a film and this compound is allowed to foam in the drying stage to form pores in the interior of the film; a method in which a coating solution containing porous solid particles and a hydrophilic binder is coated on a support to form pores in the interior of the particle or between particles; and a method in which a coating solution containing a hydrophilic binder, and solid particles and/or fine oil droplets at a volume amount equivalent to or more than the volume of the binder, is coated on a support to form pores between solid particles. In the recording medium of this invention, a protective layer may be provided on the porous layer without vitiating effects of the invention.

In this invention, the porous layer is formed preferably by allowing various kinds of inorganic particles of an average particle size of 100 nm or less.

Inorganic particles usable for the foregoing purpose include, for example, white inorganic pigments, such as light calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalsite, aluminum silicate, diatomite, calcium silicate, magnesium silicate, silica, alumina, colloidal alumina, pseudo-boehrmiter, aluminum hydroxide, lithopone, zeolite, and magnesium hydroxide.

The average particle size of inorganic particles can be determined in such a manner that particles themselves or particles appearing in the section or on the surface of a porous layer are electron-microscopically observed, 1,000 random particles are measured for their diameter and a simple average value (number-average value) thereof is defined as the average particle size. The diameter of an individual particle is represented by the diameter of a circle equivalent to the projection area of the particle.

Inorganic particles usable in this invention are preferably solid particles selected from silica alumina and alumina hydrate.

Silica used in this invention is preferably silica or colloidal silica manufactured in a conventional wet process or silica manufactured in a gas phase process, more preferably colloidal silica or fine silica particles manufactured in a gas phase process. Specifically, fine silica particles manufactured in a gas phase process are preferred, which not only exhibit a relatively high porosity but also are resistant to form coarse coagulates when adding a cationic polymer to fix a dye. Alumina or an alumina hydrate may be crystalline or noncrystalline and may further be in any appropriate form, such as amorphous particles, spherical particles or needle-like particles.

Inorganic particles are preferably dispersed in such a state that prior to being mixed with a cationic polymer, the particles are dispersed to primary particles. The particle size of inorganic particles is preferably not more than 100 nm. In the case of the foregoing particulate silica manufactured in a gas phase process, for example, the average particles size (i.e., the average size of particles dispersed in a dispersion before coating) of primary particles which are dispersed in a primary particle state, is preferably not more than 100 nm, more preferably 4 to 50 nm, and still more preferably 4 to 20 nm. Examples of silica manufactured in a gas phase process and having an average primary particle size of 4 to 20 nm include AEROSIL, commercially available from Nippon Aerosil Co. This gas phase process silica can easily be dispersed to the state of primary particles by performing suction-dispersing in water, for example, using a jet stream inductor mixer, produced by Mitamura Riken Kogyo Co., Ltd.

In this invention, the porous layer may contain a water-soluble binder. Examples of a water-soluble binder include polyvinyl alcohol, gelatin, polyethylene oxide, polyvinyl pyrrolidone, polyacrylic acid, polyacrylamide, polyurethane, dextran, dextrin, Carrageenan (κ, ι, λ), agar, pullulan, water-soluble polyvinyl butyral, hydroxyethyl cellulose and carboxymethyl cellulose. These water-soluble binders may be used in combination.

Of the foregoing binders, polyvinyl alcohol is preferred as a water-soluble binder usable in this invention. Polyvinyl alcohol usable in this invention include conventional polyvinyl alcohol obtained by hydrolysis of polyvinyl acetate, a polyvinyl alcohol cation-modified at the end, and an anion-modified polyvinyl alcohol containing an anionic group.

Polyvinyl alcohol obtained by hydrolysis of polyvinyl acetate preferably is one having an average polymerization degree of not less than 1,000, more preferably 1,500 to 5,000, and having a saponification degree of 70% to 100%, more preferably 80% to 99.5%.

A cation-modified polyvinyl alcohol is, for example, one which contains a primary-tertiary amino group or a quaternary ammonium group in the main chain or a branched chain, as described in JP-A No. 61-10483 and which can be obtained by saponification of a copolymer of a cationic group-containing ethylenically unsaturated monomer and vinyl acetate. Examples of a cationic group-containing ethylenically unsaturated monomer include trimethyl-(2-acrylamido-2,2-dimethylethyl)ammonium chloride, trimethyl-(3-acrylamido-3,3-dimethylpropyl)ammonium chloride, N-vinylimidazole, N-vinyl-2-methylimidazole, N-(3-dimethylaminopropyl)methacrylamide, hydroxyethyltrimethylammonium chloride, trimethyl-(2-methacrylamidopropyl)ammonium chloride, and N-(1,1-dimethyl-3-dimethylaminopropyl)acrylamide. The content of a cation-modified group-containing monomer is 0.1 to 10 mol %, and preferably 0.2 to 5 mol %, based on vinyl acetate.

Examples of an anion-modified polyvinyl alcohol include an anionic group containing polyvinyl alcohol, as described in JP-A No. 1-206088, a copolymer of vinyl alcohol and a hydroxyl group-containing compound, as described in JP-A No. 61-237681; and a modified polyvinyl alcohol containing a water-solubilizing group, as described in JP-A No. 7-285265.

Examples of a nonion-modified polyvinyl alcohol include a polyvinyl alcohol derivative in which a polyalkyleneoxide group is partially attached, as described in JP-A No. 7-9758; and a block copolymer of a vinyl compound and vinyl alcohol, as described in JP-A No. 8-25795.

Polyvinyl alcohols differing in polymerization degree or modification may be used in combination thereof.

The amount of inorganic particles added to a porous layer, depending on the required ink absorption capacity, porosity of the porous layer, the kind of the inorganic particles and the kind of a water-soluble binder, is usually 5 to 30 g per m of the recording medium, and preferably 10 to 25 g.

The ink-jet recording medium of this invention preferably contains cationic mordants. Cationic mordants are not specifically limited but are preferably cationic polymers or polyvalent metal salts.

Commonly known polymers are usable as a cationic polymer. Specific examples thereof include polyethyleneimine, polyallylamine, dicyandiamido-polyalkylene-polyamine, condensate of a dialkylamine and epichlorohydrin, polyvinylamine, polyvinylpyridine, polyvinylimidazole, a condensate of diallyldimethylammonium, and a quaternary compound of poly(acrylic acid ester), and cationic polymers described in JP-A Nos. 10-193776, 10-217601, 11-20300 and 10-178126 are specifically preferred.

Cationic polymers usable in this invention are not specifically limited but those having a weight-average molecular weight of 2,000 to 100,000 are specifically preferred.

Cationic polymer mordants containing a primary-tertiary amino group or a quaternary ammonium base are used as a polymer mordant. Cationic polymer mordants containing a quaternary ammonium base are preferred in terms of educed discoloration or less deterioration of light fastness during aging and being high mordant capability.

Cationic polymers usable in this invention are preferably polymers containing a quaternary ammonium base, and a homopolymer of a monomer containing a quaternary ammonium base or its copolymer with one or more other monomers are specifically preferred.

A cationic copolymer containing a quaternary ammonium base usualy has a cationic polymer content of at least 10%, preferably at least 20%, and more preferably at least 30 mol %.

Monomers containing a quaternary ammonium base may be used alone or in combination.

Cationic polymer containing a quaternary ammonium base generally exhibit high solubility in water, due to the quaternary ammonium base. However, depending on composition or proportion of a co-polymerizing monomer not containing a quaternary base, sufficient solubility in water can sometimes not be achieved. In that case, if such a cationic polymer is soluble in a water-miscible organic solvent, it is usable in this invention. Water-miscible organic solvents, which refer to organic solvents soluble in water at 10% or more, include, for example, alcohols such as methanol, ethanol, isopropanol and n-propanol; glycols such as ethylene glycol, diethylene glycol and glycerin; esters such as ethyl acetate and propyl acetate; ketones such as acetone and methyl ethyl ketone; and amides such as N,N-dimethylformamide. The content of an organic solvent is preferably less than that of water.

The weight-average molecular weight is determined in gel permeation chromatography and represented by a value converted to polyethylene glycol.

When a cationic polymer solution is added to a dispersion containing fine particles having a cationic surface, aggregates may be heavily generated. A cationic polymer having a weight-average molecular weight of 100,000 or less hardly cause such a phenomenon, whereby an almost uniform dispersion, containing no coarse particle can be easily obtained. An ink-jet recording sheet prepared using such a dispersion is expected to exhibit superior glossiness. From the same point of view, the foregoing weight-average molecular weight is preferably 50,000 or less. The lower limit of a weight-average molecular weight is usually 2,000 or more in terms of water resistance of a dye.

The ratio of the foregoing fine particles to the cationic polymer, which is variable depending on the kind or average particle size of the fine particles or the kind or weight average molecular weight, is preferably within the range of 1:0.01 to 1:1 so that the fine particles are stabilized by replacement by the cationic surface. Thus, in the foregoing range, an anionic component of fine particles is completely covered with a cationic component so that there is no fear of forming coarse particles by ionic combinations of the anionic portion of the fine particles and the cationic portion of the cationic polymer.

Specific examples of a polyvalent metal salt include sulfates, chloride, nitrates and acetates of Mg⁺², Ca⁺², Zn⁺², Zr⁺², Ni⁺², and Al⁺³, and those of Mg⁺², Zr⁺² and Al⁺³ are preferred. Inorganic polymer compounds such as basic poly(aluminum hydroxide) or zirconyl acetate are also included in examples of preferably water-soluble polyvalent metal compounds.

Zirconium containing compounds usable in this invention are those except for zirconium oxide. Specific examples thereof include zirconium difluoride, zirconium trifluoride, zirconium tetrafluoride, hexafluorozirconates (e.g., potassium salt), heptafluorozirconates (e.g., sodium salt, potassium salt, ammonium salt), octafluorozirconates (e.g., lithium salt), fluorozirconium oxide, zirconium dichloride, zirconium trichloride, zirconium tetrachloride, hexachlorozircinates (e.g., sodium salt, potassium salt), zirconium oxychloride (zirconyl chloride), zirconium dibromide, zirconium tribromide, zirconium tetrabromide, zirconium oxybromide, zirconium triiodide, zirconium tetraiodide, zirconium peroxide, zirconium hydroxide, zirconium sulfide, zirconium sulfate, zirconium p-toluenesulfonate, zirconyl sulfate, sodium zirconyl sulfate, acid zirconyl sulfate trihydrate, potassium zirconium sulfate, zirconium-selenate, zirconium nitrate, zirconyl nitrate, zirconyl phosphate, zirconyl carbonate, zirconyl carbonate ammonium, zirconium acetate, zirconyl acetate, zirconyl acetate ammonium, zirconyl lactate, zirconyl citrate, zirconyl stearate, zirconyl phosphate, zirconium oxalate, zirconium isopropylate, zirconium butyrate, zirconium acetylacetonate, acetylacetone zirconium butyrate, zirconium stearate butyrate, zirconium acetate, bis(acetylacetonato)dichlorozirconium, and tris(acetylacetonato)chlorozirconium.

Of these compounds, zirconyl carbonate, zirconyl carbonate ammonium, zirconyl acetate, zirconyl nitrate, acid zirconyl chloride, zirconyl lactate, and zirconyl citrate are preferred in terms of enhanced prevention of bleeding after printed, and zirconyl carbonate ammonium, acid zirconyl chloride and zirconyl acetate are specifically preferred. As a trade name of the foregoing compounds are cited Zirconyl Acetate ZA (trade name) and Acid Zirconyl Chloride, produced by Daiichi Kidoruigenso Kagakukogyo Co., Ltd.

Aluminum containing compounds except for aluminum oxide are usable in this invention. Specific examples thereof include aluminum fluoride, hexafluoroaluminate (e.g., potassium salt), aluminum chloride, basic aluminum chloride, (e.g. polyaluminum chloride), tetrachloroaluminates (sodium salt), aluminum bromide, tetrabromoaluminate (e.g., potassium salt), aluminum iodide, aluminates (sodiumsalt, potassium salt, calcium salt), aluminum chlorate, aluminum perchlorate, aluminum sulfate, basic aluminum sulfate, potassium aluminum sulfate (alum), ammonium aluminum sulfate (ammonium alum), sodium aluminum sulfate, aluminum phosphate, aluminum nitrate, aluminum hydrogen phosphate, aluminum carbonate, aluminum polysulfate silicate, aluminum formate, aluminum acetate, aluminum lactate, aluminum oxarate, aluminum isopropyrate, aluminum ethylacetate diisopropyrate, aluminum tris(acetylacetonate), aluminum tris(ethylacetoacetate), and aluminum monoacetylacetonate bis(ethylacetoacetonate).

Of these, aluminum chloride, basic aluminum chloride, aluminum sulfate, basic aluminum sulfate and basic aluminum sulfate silicate are preferred, and basic aluminum chloride and basic aluminum sulfate are more preferred.

When a cationic polymer or a polyvalent metal salt is used in this invention, taddition amounts are essential.

A cationic polymer is used preferably in an amount of 0.2 to 6 g per m² of recording medium. An amount of less than 0.2 g/m² results in reduced effect of inhibiting density variation by addition of polymer particles to an ink but also insufficient bleed inhibition and ozone fade prevention. An amount of more than 6 g/m² results in reduced effects of inhibiting density variation by addition of polymer particles to an ink but also insufficient resistance to ozone fading and easily causing bronzing. To manifest effects of this invention, a cationic polymer is used preferably in an amount of 1 to 6 g/m². Similarly, a polyvalent metal salt is used preferably in an amount of 0.1 to 1 g/m², and more preferably 0.4 to 0.8 g/m² to manifest the desired effects of this invention.

The porous layer preferably has a total amount of pores (total pore volume) of 20 ml or more per m² of recording medium. In a pore volume of less than 20 ml/m², superior ink absorptivity is achieved at a relative low ink quantity in printing but ink is not completely absorbed at an increased ink quantity, often producing problems such as deteriorated image quality and delayed drying.

The recording medium relating to this invention preferably has a porosity of 40% to 75%. A porosity of not less than 40% enhances the ink drying speed, inhibits beading/bleeding and leads to improved image quality. A porosity of nor more than 75% inhibits cracking or peeling caused when lightly bending the recording medium at the time of transport prior to printing. Accordingly, it reduces concern that the recording device is stained or destroyed at the time of printing, leading to markedly enhanced image quality.

In a porous layer capable of holding ink, the porosity is defined as the ratio (percentage) of total pore volume to total solid volume. A porosity of 50% or more is preferred for effective pre formation without unwanted thickening.

The ink-jet recording medium used in this invention preferably employs a hardener. A hardener may be added at any time in the course of preparing the ink-jet recording medium, for example, into the coating solution to form a porous layer.

When using a hardener in this invention, a hardener for a water-soluble binder may be supplied after formation of the porous layer but preferably, a hardener is added to a coating solution to form the porous layer.

There can be used any hardener which can cause a hardening reaction with a water-soluble binder, and boric acid or its salts are preferred but others known in the art are also usable. In general, it is a compound having a group reactive with a water-soluble binder or a compound which promotes reaction between different groups contained in the water-soluble binder. These can optimally be chosen according to the kind of a water-soluble binder. Specific examples of a hardener include epoxy type hardeners (e.g., diglycidyl ethyl ether, ethylene glycol diglycidyl ether, 1,4-butanediol diglycidyl ether, 1,6-diglycidylcyclohexane, N,N-diglycidyl-4-glycidyloxyaniline, sorbitol polyglycidyl ether, glycerol polyglycidyl ether), aldehyde type hardeners (e.g., formaldehyde, glyoxal), active halogen type hardeners (e.g., 2,4-dichloro-4-hydroxy-1,3,5-s-triazine), active vinyl type compounds (e.g., 1,3,5-trisacryloyl-hexahydro-s-triazine, bisvinylsulfonylmethyl ether) and aluminum alum.

Boric acid or its salt refers to an oxyacid having a boron atom as a central atom and its salt. Specific examples thereof include orthoboric acid, diboric acid, metaboric acid, tetraboric acid, pentaboric acid, octaboric acid and their salts. Boric acids and their salts as a hardener may be used in a single solution or a mixture of two or more solutions. Specifically, a mixed solution of a boric acid and borax is preferred. Boric acid and borax solution are each added at a relatively low concentration, but a mixture thereof can be used at a relatively high concentration. In addition, the pH of an aqueous solution to be added can easily be controlled.

The total amount of hardeners to be used is preferably 1 to 600 mg per g of a water-soluble binder.

Subsequently, there will be described a support used in the ink-jet recording medium.

A support usable in this invention can be optimally chosen from supports conventionally used as an ink-jet recording medium, for example, a paper support such as plain paper, art paper coat paper and cast coat paper, a plastic support, a paper support double-coated with polyolefin on both sides and a composite support laminated with the foregoing supports. A non-water-absorbing support is preferred in this invention. The non-water-absorbing support is a support comprised of material and closeness not allowing water to permeate. As a non-water-absorbing support is specifically preferred a plastic support or a paper support double-coated with polyolefin, which is also superior in oxidizing gas resistance. These non-water-absorbing supports can obtain printed images close to photographic image quality at a relatively low cost.

Hereinafter, there will be described a paper support which is coated with polyolefin on both sides of raw paper.

Raw paper used for a paper support is made using wood pulp as a main raw material and optionally a synthetic pulp such as polypropylene or a synthetic fiber such as nylon or polyester. Any one of wood pulps of LBKP, LBSP, LBKP, NBSP, LDP, NDP, LUKP and NUKP is usable but the use of LBKP, NBSP, LBSP, NDP or LDP, each having a relatively high short fiber content, is preferred, provided that the content of LBSP and/or LDP is preferably 10% to 76% by weight.

Of the foregoing pulps, a chemical pulp (sulfate pulp or sulfite pulp) having a relatively low impurity content is preferable. There is also usable a pulp which has been subjected to a bleaching treatment to increase whiteness. There may be optionally added to raw paper, a higher fatty acid a sizing agent such as alkylketene dimmer, a white pigment such as calcium carbonate, talc, or titanium oxide, strength-enhancing agent such as starch, polyacrylamide or polyvinyl alcohol, a brightener, a moisture-retention agent such as polyethylene glycol, a dispersing agent, and a softening agent such as quaternary ammonium.

The freeness of the pulp used for paper-making is preferably 200 to 500 ml, as defined in CSF. With respect to a fiber length after beating, the sum of the weight percent (wt %) of 24 mesh residue and that of 2% mesh residue, as defined in JIS-P-8270, is preferably 30% to 70% by weight. The 4 mesh residue is preferably not more than 20% by weight. The weight of raw paper is preferably 30 to 250 g/m², and more preferably 50 to 200 g/m². The thickness of raw paper is preferably 40 to 250 μm. Raw paper may be subjected to calender finishing during or after paper-making to provide higher smoothness. The density of raw paper (as defined in JIS-P-8118) is usually 0.7 to 1.2 g/cm³. The stiffness of raw paper is preferably 20 to 200 g under the condition, as defined in JIS-P-8143. The raw paper surface may be coated with a surface sizing agent. Sizing agents which can be added to raw paper, as described above, are also usable as a surface sizing agent. The pH of raw paper is preferably 5 to 9 when measured in accordance with the hot-water extraction method defined in JIS-P-8113.

Polyethylene used for covering the front and back surface of the raw paper is mainly low density polyethylene (LDPE) and/or high density polyethylene (HDPE). In addition, linear low density polyethylene (LLDPE) or polypropylene may be partially used. Specifically, as conventionally used in photographic print paper, rutile or anatase type titanium oxide is preferably added into the polyethylene of a polyethylene layer on the porous layer side to improve opacity and whiteness. The titanium oxide content is usually 3% to 20% by weight, and preferably 4% to 13%.

Polyethylene coated paper is usable as glossy paper or may be subjected to embossing to form a matt surface or silk surface when coating polyethylene on the raw paper surface by melt extrusion.

The coating amount of polyethylene on the front and back surface of raw paper is chosen so as to optimize curling under low and high humidity conditions after providing a porous layer or a back layer, but usually, a polyethylene layer on the porous layer side is 20 to 40 μm thick and that on the back layer side is 10 to 30 μm thick.

The foregoing polyethylene coated paper preferably exhibits the following characteristics:

1. Tensile strength: preferably 20 to 300 N in the longitudinal direction and 10 to 200 N in the lateral direction in terms of strength defined in JIS-P-8113,

2. Tear strength: preferably 0.1 to 20 N in the longitudinal direction and 2 to 20 N in the lateral direction in the method defined in JIS-P-8116,

3. Compressive elastic modulus≧98.1 Mpa,

4. Surface Bekk smoothness: preferably 20 sec. or more for a glossy surface, under the condition defined in JIS-P-8119, but being less than that for so-called embossed material,

5. Opacity: preferably not less than 80%, more preferably 85% to 98% when measured in the method defined in JIS-P-8138,

6. Whiteness: preferably L*=80 to 95, a*=−3 to +5 and b*=−6 to +2, in terms of L*, a* and b* as defined in JIS-Z-8729,

7. Surface glossiness: preferably 10% to 95% in terms of specular glossiness at 60 degrees, as defined in JIS-Z-8741,

8. Clark rigidity: preferably a support exhibiting a Clark rigidity of 50 to 300 cm²/100 in the transport direction of the recording medium, and

9. Moisture content of base paper: usually 2% to 100%, and preferably 2% to 6% by weight, based on the base paper.

The ink-jet recording medium relating to this invention preferably exhibits a mean surface roughness (Ra) of 20 to 100 nm. In a porous recording medium, a mean surface roughness of 20 nm or more forms sufficient pores, achieving sufficient ink absorptivity and preventing ink-flooding. A surface mean roughness of 100 nm or less achieves enhanced surface smoothness and glossiness. The mean surface roughness is defined in JIS-B-0601.

Hereinafter, a manufacturing method of a recording medium relating to this invention will be described.

An ink-jet recording medium can be manufactured by coating the respective constituent layers including a porous layer singly or simultaneously on a support by selecting a method from commonly known coating systems and then drying. Examples of a coating system include a roll coating method, a rod-bar coating method, an air-knife coating method, a spray coating method, a curtain coating method, a slide bead coating method by using a hopper, as described in U.S. Pat. Nos. 2,761,419 and 2,761,791 and an extrusion coating method.

When performing simultaneous multilayer coating by a slide bead coating system, the viscosity of the individual coating solution is preferably in the range of 5 to 100 mPa·s, more preferably 10 to 50 mPa·s. When using a curtain coating system, the viscosity is preferably in the range of 5 to 1200 mPa·s, and more preferably 25 to 500 mPa·s. The viscosity of a coating solution at 15° C. is preferably not less than 100 mPa·s, more preferably 100 to 30,000 mPa·s, still more preferably 3,000 to 30,000 mPa·s, and further still more preferably 10,000 to 30,000 mPa·s.

It is preferred to heat a coating solution to 30° C. or more and conduct simultaneous multilayer coating, followed by cooling the coat to a temperature of 1 to 15° C. and drying at 10° C. or more. Preparation of a coating solution for the upper most layer containing a thermoplastic resin, coating and drying thereof is conducted preferably at a temperature lower than Tg of the thermoplastic resin to inhibit film-forming of the thermoplastic resin. More preferably, drying is conducted at a wet bulb temperature of 5 to 50° C. and a film surface temperature of 10 to 50° C. Cooling immediately after coating is conducted in a horizontal set system in terms of uniformity of the coated layer.

An ink-jet head usable in the ink-jet recording method of this invention may be an on-demand system, a continuous system or any one capable of providing water-soluble dye inks and a colorless ink. Specific examples of an ejection system include an electric to mechanical conversion system (e.g., single cavity type, double cavity type, bender type, piston type, share mode type, shared wall type), an electric to heat conversion system (e.g., thermal ink-jet type, bubble jet (trade name) type), an electrostatic suction system (e.g., electric field control type, slit-jet type), and a discharge system (e.g., spark jet type), and anyone of the foregoing ejection systems is usable.

A series of printer sets comprised of a roll-form recording medium mounting unit, a transport section, an ink-jet print head, a cutter, a pressurizer, and optionally a heating section and a recorded print storage unit is useful in commercial employment of ink-jet photographs.

There are also described techniques of providing colorless inks in JP-A Nos. 8-85218, 2001-47644, 2001-277488 and 2003-191601.

In order to promote film formation of water-dispersible polymer particles in the ink-jet recording method of this invention, heating the ink-jet recording medium before or during recording, or subjecting the recorded material to a heating or pressurizing treatment after recording is one of preferred embodiments of this invention.

### EXAMPLES

The present invention will be further described based on examples but is by no means limited to these. In the following examples, designation “part(s)” and “%” represent part(s) by weight and % by weight, respectively, unless otherwise noted.

### Preparation of Ink Set

Ink sets 1 through 19 were each prepared in the manner as below.

Ink Set 1

Preparation of Deep Color Ink (Yellow, Magenta, Cyan, Black)

| | |
|---|---|
| Propylene glycol | 10.0% |
| Glycerin | 10.0% |
| Triethylene glycol monobutyl ether | 10.0% |
| Dye | 3.0% |
| SURFINOL 465 (produced by Nisshin | 0.5% |
| Kagaku Kogyo Co., Ltd.) | |
| Water-dispersible polymer particle | 1.0% solid |
| (acryl emulsion, Tg < 5° C., average | |
| particle size of 80 nm) | |
| Water-soluble resin PVA 105 (polyvinyl | 0.5% |
| alcohol, produced by KURARAY Co., LTD.) | |
| Pure water | to make 100% |

Four deep color inks of yellow, magenta, cyan and black were obtained using dyes of C.I. Direct Yellow 86 for the yellow ink, C.I. Direct Red 227 for the magenta ink, C.I. Direct Blue 199 for the cyan ink and C.I. Food Black 2 for a black ink.

Preparation of Light Color Ink (Magenta, Cyan)

| | |
|---|---|
| Propylene glycol | 10.0% |
| Glycerin | 10.0% |
| Triethylene glycol monobutyl ether | 10.0% |
| Dye | 0.8% |
| Surfinol 465 (produced by Nisshin | 0.5% |
| Kagaku Kogyo Co., Ltd.) | |
| Water-dispersible polymer particle | 1.0% solid |
| (acrylic resin emulsion, Tg < 5° C., | |
| average particle size of 80 nm) | |
| Water-soluble resin PVA 105 (polyvinyl | 0.5% |
| alcohol, produced by KURARAY CO., LTD.) | |
| Pure water | to make 100% |

Two light color inks of magenta and cyan were obtained using dyes of C.I. Direct Red 227 for the magenta ink and C.I. Direct Blue 199 for the cyan ink.

Ink Sets 2 through 19

Ink sets 2 through 19 were each prepared similarly to the deep color ink and the light color ink of the foregoing ink set 1, provided that the water-dispersible polymer particles and the water-soluble resin were replaced by a water-dispersible polymer particles having the Tg and the average particle size shown in Table 1 and the water-soluble resin in the amount shown in Table 1.

Preparation of Colorless Ink

A colorless ink was prepared as following composition:

| | |
|---|---|
| Propylene glycol | 10.0% |
| Glycerin | 10.0% |
| Triethylene glycol monobutyl ether | 10.0% |
| Surfinol 465 (produced by Nisshin | 0.5% |
| Kagaku Kogyo Co., Ltd.) | |
| Water-dispersible polymer particle | 1.0% solid |
| (acrylic resin emulsion, Tg = 10° C., | |
| average particle size of 60 nm) | |
| Water-soluble resin PVA 105 (polyvinyl | 0.4% |
| alcohol, produced by KURARAY CO., LTD.) | |
| Pure water | to make 100% |

### Preparation of Recording Medium

Recording mediums 1 through 3 were prepared in the manner as described below.

Recording Medium 1

Polyethylene containing 6% anatase type titanium oxide was coated by melt extrusion at a thickness of 35 μm on the surface of photographic raw paper having a moisture content of 8%. Polyethylene was also coated by melt-extrusion at a thickness of 40 μm on the back surface. After subjecting the front surface side to corona discharge, polyvinyl alcohol (PVA 235, produced by KURARAY CO., LTD.) was coated thereon at 0.05 g/m² to form a sublayer. After subjecting the back surface side to corona discharges a back layer containing 0.4 g of a latex binder of a styrene/acrylic acid ester type exhibiting a Tg of approximately 8° C., 0.1 g of an antistatic agent (cationic polymer) and 0.1 g of approximately 2 μm silica was coated onto the back surface side. On the surface side of the obtained approximately 220 μm thick resin-coated raw paper (RC paper), the following porous layer constituents were coated at the coating amounts as below to prepare recording medium 1. In the preparation of recording medium 1, a surfactant and boric acid were added at appropriate amounts. The thus prepared recording medium 1 was wound into a 12.7 cm wide roll paper.

Porous Layer Coating Solution

| | |
|---|---|
| Gas phase-prepared silica (A-300, | 22.0 g/m² |
| (produced by Nippon Aerogyl Kogyo Co., Ltd. | |
| average primary particle, size, 7 nm) | |
| Polyvinyl alcohol (PVA 235, produced | 3.9 g/m² |
| by KURARAY CO., LTD.) | |
| Cationic polymer P-1 | 2.3 g/m² |
| Ratio of Silica/(water-soluble binder + | 3.55 |
| cationic polymer) | |

Cationic polymer P-1

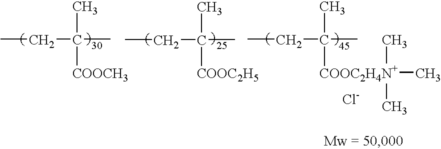

Recording Medium 2

Recording medium 2 was prepared similarly to the foregoing recoding medium 1, provided that coating amounts of the porous layer constituents were varied as below.

| | | |
|---|---|---|
| Silica (A-300) | 19.0 | g/m² |
| Polyvinyl alcohol (PVA 235) | 3.6 | g/m² |
| Cationic polymer P-1 | 2.8 | g/m² |

| | |
|---|---|
| Ratio of Silica/(water-soluble binder + cationic | 2.97 |
| polymer) | |

Recording Medium 3

Recording medium 3 was prepared similarly to the foregoing recoding medium 1, provided that constituents and coating amounts of the porous layer were varied as below.

| | | |
|---|---|---|
| Alumina (Cataloid, Produced by | 45.0 | g/m² |
| Shokubai Kagaku Co.) | | |
| Polyvinyl alcohol (PVA 117, | 4.0 | g/m² |
| produced by KURARAY CO., LTD.) | | |
| Cationic polymer P-1 | 1.0 | g/m² |

| | |
|---|---|
| Ratio of alumina/(water-soluble binder + cationic | 9.0 |
| polymer) | |

TABLE 1

| | Water-dispersible | | | | | | | |
|---|---|---|---|---|---|---|---|---|
| | Polymer Particle | | | Water-soluble Resin | | | | |
| Ink Set | | Average Size | Amount (a) | | Amount | | | |
| No. | Tg (° C.) | (nm) | (%) | Resin | (b) (%) | a + b (%) | b/a | Remark |
| 1 | <5 | 80 | 1.0 | PVA105 | 0.5 | 1.5 | 0.50 | Inv. |
| 2 | <5 | 80 | 1.5 | — | — | 1.5 | — | Comp. |
| 3 | <5 | 30 | 1.0 | — | — | 1.0 | — | Comp. |
| 4 | <5 | 30 | 1.0 | PVA105 | 0.5 | 1.5 | 0.50 | Comp. |
| 5 | 5 | 220 | 1.0 | — | — | 1.0 | — | Comp. |
| 6 | 5 | 220 | 1.0 | PVA105 | 0.5 | 1.5 | 0.50 | Comp. |
| 7 | <5 | 80 | 0.8 | PVA105 | 0.2 | 1.0 | 0.25 | Inv. |
| 8 | <5 | 80 | 2.0 | PVA105 | 0.8 | 2.8 | 0.40 | Inv. |
| 9 | <5 | 80 | 3.0 | PVA105 | 1.2 | 4.2 | 0.40 | Comp. |
| 10 | <5 | 80 | 1.3 | PVA105 | 0.2 | 1.5 | 0.15 | Inv. |
| 11 | <5 | 80 | 0.8 | PVA105 | 0.7 | 1.5 | 0.88 | Inv. |
| 12 | <5 | 80 | 0.5 | PVA105 | 1.0 | 1.5 | 2.0 | Comp. |
| 13 | <5 | 30 | 1.0 | PEG#8000 | 0.5 | 1.5 | 0.50 | Comp. |
| 14 | <5 | 40 | 1.0 | PEG#8001 | 0.5 | 1.5 | 0.50 | Inv. |
| 15 | <5 | 120 | 1.0 | PEG#8002 | 0.5 | 1.5 | 0.50 | Inv. |
| 16 | <5 | 180 | 1.0 | PEG#8003 | 0.5 | 1.5 | 0.50 | Inv. |
| 17 | <5 | 220 | 1.0 | PEG#8004 | 0.5 | 1.5 | 0.50 | Comp. |
| 18 | 10 | 60 | 1.0 | PVA105 | 0.4 | 1.4 | 0.40 | Inv. |
| 19 | 30 | 60 | 1.0 | PVA105 | 0.4 | 1.4 | 0.40 | Inv. |

*PEG: polyethylene glycol

### Ink Jet Recording Method

Using a printer with seven recording heads (piezo type, 512 nozzles) on a carriage, an individual ink set (6 color heads) and a colorless ink were set and printing was performed at 1440 dpi×1440 dpi and (dpi=number of dots per inch or 2.54 cm) using each of the prepared roll-form recording mediums 1 to 3 at a conveyance speed of 18 m/hr to obtain Records 1 to 23.

The colorless ink used in Records 20, 21 and 23 was provided onto non-printed areas of the individual ink set at the same ejection amount as the maximum ejection amount of the respective ink sets (6 color heads).

### Evaluation of Recorded Material

Ozone Fade Resistance

According to the foregoing ink-jet recording method, a neutral image (having a reflection density of 0.9 for each of yellow, magenta and cyan) and a cyan solid image (having a cyan reflection density of 0.5) were printed to obtain Records 1 to 23. The thus obtained recorded materials were allowed to stand under an environment at an ozone concentration of 6 ppm (at 25° C., 50% RH) over a period of 20 hrs. Images before and after being thus faded were visually compared and evaluated with respect to ozone fade resistance, based on the following criteria:
5: no variation in density of an imag area was observed between before and after the fading treatment,
4: variation in density of an image area was not nearly observed between before and after the fading treatment,
3: slight variation in density of an image area was observed between before and after the fading treatment,
2: variation in density of an image area was observed between before and after the fading treatment,
1: markedly lowering in density of an image area was observed between before and after the fading treatment.
   Ink Absorptivity

According to the foregoing ink-jet recording method, a 10-step wedge image of reddish brown was printed and the step number at which beading was caused, was noted. No beading being observed even at the 10th step was designated “no occurrence”, representing most superior ink absorptivity. Subsequently, as the step number value decreases from 10 to 9, 8, 7 and so on, it represents occurrence of beading even at a lower ink-providing quantity.

Glossiness

According to the foregoing ink-jet recording method, a black solid image and a white background (a colorless ink was provided in recorded materials 20, 21 and 23) were obtained and measured with respect to the C value (%) using an image clarity tester (ICM-1DP, produced by Suga Shikenkikai Co.) to determine the difference in glossiness between the solid black image and the white background as a measure of uniformity of glossiness.

Ink Ejectability

Images were continuously outputted over 30 min. by continuous ejection of the respective heads. After completing ejection, outputted images were visually observed with respect to presence/absence of nozzle deficiency and evaluated as a measure of ink ejection capability (hereinafter, also denoted simply as ejectability), based on the following criteria:
A: no nozzle deficiency noted,
B: 1 or 2 nozzle deficiencies noted,
C: 3 or more nozzle deficiencies noted.
   Surface Strength

Using the foregoing printer, a solid image exhibiting a density of 1.0 was printed on the obtained recording medium and evaluated with respect surface strength by noting the presence/absence of partial image lose on the recorded image, caused by transport rollers (also called as notched digging), based on the following criteria:
A: no image lose was noted and no problem in practice,
B: slight recess of the image surface was noted but causing no lowered image quality and acceptable in practice,
C: loss of at least a part of the image was noted and not acceptable in practice.

The thus obtained results are shown in Table 2.

TABLE 2

| | | | | Ozone Fade | | | | | | | | |
|---|---|---|---|---|---|---|---|---|---|---|---|---|
| | | | | Resistance | | | | | | | | |
| | Ink | | Recording | | Cyan | | Glossiness (C value %) | | | | | |
| Record | Set | Colorless | Medium | Neutral | Solid | Ink | Imaging | White | | | | |
| No. | No. | Ink | No. | Image | Image | Absorptivity | Area | Background | Difference | *1 | *2 | Remark |
| 1 | 1 | — | 1 | 5 | 3 | 8 | 70 | 50 | 20 | A | A | Inv. |
| 2 | 2 | — | 1 | 4 | 2 | 7 | 65 | 50 | 15 | C | A | Comp. |
| 3 | 3 | — | 1 | 4 | 2 | 5 | 60 | 50 | 10 | C | C | Comp. |
| 4 | 4 | — | 1 | 4 | 3 | 3 | 60 | 50 | 10 | C | C | Comp. |
| 5 | 5 | — | 1 | 3 | 1 | 8 | 50 | 50 | 0 | C | B | Comp. |
| 6 | 6 | — | 1 | 4 | 2 | 8 | 55 | 50 | 5 | C | B | Comp. |
| 7 | 7 | — | 1 | 5 | 3 | * | 70 | 50 | 20 | A | A | Inv. |
| 8 | 8 | — | 1 | 5 | 4 | 7 | 65 | 50 | 15 | A | B | Inv. |
| 9 | 9 | — | 1 | 5 | 5 | 6 | 65 | 50 | 15 | B | C | Comp. |
| 10 | 10 | — | 1 | 5 | 4 | 7 | 65 | 50 | 15 | B | A | Inv. |
| 11 | 11 | — | 1 | 5 | 4 | 8 | 70 | 50 | 20 | A | A | Inv. |
| 12 | 12 | — | 1 | 4 | 3 | 6 | 70 | 50 | 20 | A | C | Comp. |
| 13 | 13 | — | 1 | 5 | 3 | 3 | 60 | 50 | 10 | A | C | Comp. |
| 14 | 14 | — | 1 | 5 | 4 | 7 | 70 | 50 | 20 | A | A | Inv. |
| 15 | 15 | — | 1 | 5 | 4 | 8 | 65 | 50 | 15 | A | A | Inv. |
| 16 | 16 | — | 1 | 5 | 4 | 8 | 65 | 50 | 15 | A | A | Inv. |
| 17 | 17 | — | 1 | 4 | 2 | 8 | 50 | 50 | 0 | B | B | Comp. |
| 18 | 18 | — | 1 | 5 | 4 | * | 80 | 50 | 30 | A | A | Inv. |
| 19 | 19 | — | 1 | 5 | 4 | * | 75 | 50 | 25 | A | A | Inv. |
| 20 | 18 | Yes | 1 | 5 | 5 | 8 | 80 | 80 | 0 | A | A | Inv. |
| 21 | 18 | Yes | 2 | 5 | 4 | 8 | 80 | 80 | 0 | A | A | Inv. |
| 22 | 18 | — | 3 | 5 | 4 | * | 80 | 50 | 30 | A | A | Inv. |
| 23 | 18 | Yes | 3 | 5 | 5 | * | 80 | 80 | 0 | A | A | Inv. |

*: no beading noted
*1: Ink Ejectability
*2: Surface Strength

As is apparent from the results shown in Table 2, it was proved that an ink set composed of inventive inks containing water-dispersible polymer particles having a specific average particle size in combination with a water-soluble resin exhibited superior ink ejection capability and enhanced ink-absorbing rate, resulting in printed images exhibiting improved ozone fade resistance and superior glossiness.

What is claimed is:

1. An ink-jet ink comprising a water-soluble dye, a water-soluble organic solvent water-dispersible polymer particles and a water-soluble resin, wherein the water-dispersible polymer particles have an average particle size of 40 to 200 nm and a total content of the water-dispersible polymer particles and the water-soluble resin being 0.5% to 4.04% by weight of the ink and a ratio of a content of the water-soluble resin to that of the water-dispersible polymer particles being 0.1 to 1.0.

2. The ink-jet ink of claim 1, wherein the average particle size of the water-dispersible polymer particles is 40 to 150 nm.

3. The ink-jet ink of claim 1, wherein the average particle size of the water-dispersible polymer particles is 40 to 100 nm.

4. The ink-jet ink of claim 1, wherein the water-dispersible polymer exhibits a glass transition temperature of −30 to 80° C.

5. The ink-jet ink of claim 1, wherein the water-dispersible polymer exhibits a minimum film-forming temperature of 0 to 80° C.

6. The ink-jet ink of claim 1, wherein the water-soluble resin is at least one selected from the group consisting of a polyvinyl alcohol, carboxymethyl cellulose and a polyethylene oxide.

7. The ink-jet ink of claim 1, wherein the water-soluble resin is contained in an amount of 0.2 to 2.0% by weight of the ink.

8. An ink-jet ink set comprising at least one color ink and a colorless ink, wherein the color ink is an ink as claimed in claim 1.

9. The ink-jet ink set of claim 8, wherein the colorless ink comprises a water-dispersible polymer particles.

10. The ink-jet ink set of claim 9, wherein the colorless ink comprises a water-soluble resin.

11. An ink-jet recording method comprising ejecting a color ink to allow the color ink to deposit onto a porous recording medium to form a print, wherein the color ink is an ink as claimed in claim 1.

12. The ink-jet recording method of claim 11, wherein the method further comprises ejecting a colorless ink to allow the colorless ink to deposit in an unprinted area of the recording medium, provided that an ink droplet amount per a unit area of the recording medium of the colorless ink is greater than that of the color ink.

13. The ink-jet recording method of claim 11, wherein the recording medium comprises a support having thereon a porous layer containing fine particles, a water-soluble binder and a cationic polymer, and a ratio of weight of the fine particles to that of the water-soluble binder and the cationic polymer being 3 to 12.

14. The ink-jet recording method of claim 13, wherein the fine particles are inorganic particles having an average particle size of 100 nm or less.

15. The ink-jet recording method of claim 14, wherein the inorganic particles is solid particles selected from the group consisting of silica, alumina and an alumina hydrate.

16. The ink-jet recording method of claim 13, wherein the porous layer exhibits a porosity of 50% or more.
